(19) United States
(12) Patent Application Publication
(10) Pub. No.: US 2024/0139828 A1
(43) Pub. Date: May 2, 2024

(54) DRILL HEAD AND METHOD FOR MANUFACTURING SUCH DRILL HEAD

(71) Applicant: Kennametal Inc., Latrobe, PA (US)

(72) Inventors: Kay Ulbig, Bamberg (DE); Juergen Schwaegerl, Vohenstrauss (DE); Matthias Zitzmann, Wernberg-Koblitz (DE); Sebastian Kunschir, Winklam (DE); Patrick Kuhlemann, Fuerth (DE); Horst Manfred Jäger, Nuemberg (DE); Georg Roth, Leutenbach (DE)

(21) Appl. No.: 18/490,291

(22) Filed: Oct. 19, 2023

(30) Foreign Application Priority Data
Oct. 26, 2022 (DE) 102022211370.5

(51) Int. Cl. B23B 27/22; B23B 27/14; B33Y 80/00

(52) U.S. Cl. CPC B23B 27/22; B23B 27/143; B33Y 80/00; B23B 2210/06

(57) ABSTRACT

The invention relates to a drill head comprising at least one surface, with a number of structural elements, wherein the structural elements are manufactured by an additive or primary forming manufacturing method. The invention further relates to a method for manufacturing such a drill head.

### RELATED APPLICATION DATA

This application claims priority under 35 U.S.C. § 119(a) to German Patent Application No. 102022211370.5, filed on Oct. 26, 2022, which is incorporated by reference herein in its entirety.

### FIELD

The invention relates to a drill head as well as a method for manufacturing such a drill head.

### BACKGROUND

A drill head is workpiece of a drill and serves to realize the primary function of the drill, namely to lift chips from a workpiece by rotation about a longitudinal axis. Accordingly, the drill head forms a front end of the drill and has a number of main cutting edges that engage with the workpiece during operation, thereby lifting away chips. The chips are regularly fed towards the rear of the drill via chip flutes. The chip flutes are arranged, for example, in a coiled fashion. Generally, one chip flute is given for each main cutting edge, which chip flute runs ahead of the corresponding main cutting edge and receives the chips manufactured there.

A drill head is manufactured, for example, by grinding in the required geometries, specifically of the main cutting edges and of the chip flutes. A grinding wheel is used for this purpose, for example, but this limits the design freedom when determining the geometries.

Some materials form particularly long chips during the machining. This is particularly problematic in the case of drills, because such long chips can quickly clog the chip flutes. It is therefore generally desirable to produce shorter chips. By contrast, long chips are significantly less problematic in the case of milling tools or rotary tools, so that completely different boundary conditions and objectives also result here.

### SUMMARY

In light of the foregoing, a problem addressed by the invention is to specify an improved drill head as well as an improved method for manufacturing a drill head. The method is to provide as much design freedom as possible in the configuration of the drill head. The drill head is then intended to enable an improved machining of a workpiece.

The problem is solved according to the invention by a drill head having the features according to claim 1 as well as by a method having the features according to claim 14. Advantageous configurations, further developments, and variants are the subject matter of the subclaims. The statements made in connection with the drill head apply analogously to the method. To the extent that structural features of the drill head are specified below, advantageous embodiments of the method result from the fact that one or more of these structural features are manufactured with said method. The problem is in particular also solved by a drill comprising a drill head as described below.

The drill head is used in particular in a drill or is part of a drill. The drill, when used as intended, serves to lift chips from a workpiece by a rotation of the drill about a longitudinal axis. The workpiece, and consequently also the chips lifted off the drill head, are in particular made of a ductile material. In addition to the drill head, the drill generally has a shaft. The shaft extends in particular in a longitudinal direction and is configured on the rear side such that it is receivable in a machine tool. The drill head is mounted on the front side of the shaft, either detachably (modular drill) or fixed (non-detachably fastened or integral drill). A modular drill is preferred in the present case. In the case of a modular drill, the drill head comprises a coupling element on the rear side for coupling to a complementary coupling element of the shaft arranged on the front side. The drill head is preferably not a plate-shaped insert, but is rather round and generally cylindrical or tapered in form, or a combination thereof. In particular, the drill head has a diameter that typically, but not necessarily, corresponds to a diameter of the shaft, irrelevant of any slight (<5%) tapering to the rear side. The drill head is also referred to as a “drill tip” and, specifically in the case of a modular drill, is also referred to as an “insert.”

The drill head has at least one surface with a number of structural elements. “A number of” is generally understood to mean “one or more.” The surface is in particular a working surface of the drill head, i.e., a surface which, when the drill head is used as intended, comes into contact with a workpiece or chips thereof. In the present case, preferred surfaces of the drill head are an open face, a chip face or a grooved face of a chip flute, a point or a lateral face, specifically a chamfer or an ancillary cutting edge of the lateral face. These surfaces will be discussed in further detail below. A combination is also possible, so that a plurality of the aforementioned surfaces each have a number of structural elements.

The structural elements are manufactured by an additive or primary forming manufacturing method. In particular, the structural elements are ultimately manufactured by this additive or primary forming manufacturing method, i.e., after the formation of the structural elements by the additive or primary forming manufacturing method, no further processing of the structural elements takes place. The structural elements are in particular manufactured not individually and/or independently of the surface and/or later applied to the surface, but are in particular an integral component of the surface for manufacturing purposes. The surface is defined in particular by the structural elements.

A core concept of the invention is, in particular, to produce one or more surfaces of the drill head not by grinding them in with a grinding wheel, thereby circumventing the associated limitation of design freedom. This surface can then be designed freely and independently of a grinding wheel. This makes it possible to create completely different, previously inaccessible geometries on the surface and thereby specifically improves the operation of the drill head. In this way, structural elements can in particular be manufactured that act as a chip breaker, a chip guide structure, an operating means guide structure (operating means are in particular coolants and/or lubricants), a thermal conductive structure, a friction reduction, an improvement in sliding, and/or the like. A specific design for the structural elements is expediently obtained by means of a computer simulation, in which, for example, the chip formation on the drill head is simulated with structural elements, taking into account a surface. Accordingly, a variety of specific configurations are generally conceivable.

In particular, the drill head comprises at least one main cutting edge and one chip flute, which runs ahead of the main cutting edge. Typically, the drill head has a plurality, e.g., two to four, of main cutting edges and the same number of flutes. Preferably, the drill head is at least two-edged, i.e., in particular, having at least two main cutting edges, each being a full cutting edge. The presently preferred full cutting edges stand in contrast in particular to partial cutting edges formed with cutting inserts on so-called indexable drills. The main cutting edges generally extend from a center of the drill head up to a lateral face of the drill head, i.e., from inward to outward, and thus roughly in a radial direction. Accordingly, the main cutting edges are advantageously full cutting edges and thus cover in particular an entire radius of the drill, by contrast to so-called partial cutting edges, which only extend partially from the center to the lateral face and then cover the entire radius of the drill in combination with further partial cutting edges. The radial direction is perpendicular to the longitudinal axis. “Running ahead” is understood to mean that, during operation, the chip flute runs ahead of the corresponding main cutting edge in a circumferential direction of the drill, so that chips which are generated at the main cutting edge are guided into the chip flute and, by means of said chip flute, towards the rear side of the drill.

In one advantageous embodiment, the surface is a chip face, which is a part of the chip flute. The chip face directly adjoins the main cutting edge. The chip face is not necessarily the entire surface of the chip flute, but optionally only a portion thereof. In any case, however, the chip face directly adjoins the main cutting edge and is thus the region of the chip flute that first comes into contact with the chips. The chip face preferably faces in the circumferential direction and then extends at least predominantly in the direction of the longitudinal axis (longitudinal direction) as well as in the radial direction. The chip face defines the so-called chip angle, i.e., the angle between the longitudinal axis and the chip face. In particular, the chip flute is divided into the chip face on the one hand and a grooved face on the other (i.e., the chip face is thus only a portion of the chip flute). The grooved face lies further inward in the drill head relative to the chip face. The grooved face is in particular groove-shaped, i.e., concave, and thus forms a channel that opens in the radial direction in the center of the drill head. In a suitable configuration, the grooved face is ground in, or at least polished, by means of a grinding wheel. However, this is not mandatory. In particular, the chip face and the grooved face join one another at an edge or alternatively continuously transition into one another. The chip face is preferably bordered by the main cutting edge, the grooved face, and a lateral face of the drill head. A chip generated on the main cutting edge first passes to the chip face and then, from there, to the grooved face in order to be ultimately discharged towards the rear side. Thus, in general, the chip face forms an inlet region of the chip flute for chips and serves in particular to influence the chips by means of the structural elements. The grooved face then serves primarily, but not necessarily exclusively, for the downstream removal of the chips. The grooved face is in particular a front-side end of a generally groove-shaped portion of the chip flute, which e.g., is coiled or runs straight from the front side of the drill towards its rear side. In an expedient embodiment, a number of structural elements are also arranged in the grooved face and/or one or more of the structural elements of the chip face extend into the grooved face.

Analogously to the chip flute, an open face of the drill head in particular adjoins the main cutting edge on the rear side. During operation, it is typically not in complete contact with the workpiece, but rather forms a so-called clearance angle with it. A formation of structural elements is also advantageous for the open face.

Due to the structural elements, the surface is structured, macro-structured, i.e., in particular with structural dimensions, i.e., width, length, height, diameter, of at least 0.2 mm (i.e., in particular not microstructured), at most in particular 3 mm. Preferably, the surface comprises a plurality of structural elements, e.g., 2 to 300 pieces, depending on the configuration and arrangement of the structural elements. Other structural dimensions and numbers can also be beneficial depending on the specific application and details of the manufacturing method of the drill head. In particular, it is essential that the surface is not merely smooth, which is typically achieved by grinding-in with a grinding wheel. Rather, the surface is structured by the additional structural elements, i.e., has a non-smooth surface (also known as a topology), which is significantly more complex than a simple smooth surface achieved by grinding-in. In particular, the structural elements described herein cannot be manufactured by grinding-in with a grinding wheel.

In a suitable configuration, the structural elements are entirely or predominantly (>95%) a part of the surface and therefore do not pass or only minimally pass into other surfaces of the drill head. The structural elements thus exclusively serve to structure this individual surface. However, a structuring and influencing of a plurality of surfaces with structural elements is also generally advantageous.

As already described, instead of grinding-in (subtractive), an additive or a primary forming manufacturing method is used in order to manufacture the drill head and specifically the structural elements. Particularly preferred is an injection molding method, i.e., the drill head is manufactured along with the structural elements in an injection molding method. In other words, the drill head is manufactured by an injection molding method. In the injection molding method, a material for producing the drill head is liquefied and placed into a mold and then cooled. After cooling, the mold is opened and the drill head is demolded. This basically differs from the production of so-called cutting inserts, for which the corresponding material is not liquefied but rather pressed into the mold as a powder. In this respect, findings from the manufacture of cutting inserts are not readily transferable to the manufacture of drill heads. As an alternative to an injection molding method, a 3D printing method is also suitable, which is however typically more expensive.

Preferably, the drill head is in particular made entirely of carbide (specifically tungsten carbide). For injection molding in the context of the injection molding method, suitable additives, in particular wax or plastic, are added to the carbide in order to obtain a suitable material.

The drill head is also preferably manufactured integrally, in particular as a result of the injection molding method. “Integral” is understood to mean in particular “monolithic” or “completely made of only a single material.”

In a suitable configuration, subsequently, i.e., after injection molding and demolding, the drill head is polished, in particular with a grinding wheel. However, at least the structural elements are omitted so that they remain unground, preferably even the entire surface with the structural elements is omitted from the grinding. This predominantly preserves the structural elements, which would be lost by grinding of the surface. For the surface and specifically for its structural elements, the injection molding method is generally then the last and thus final form-determining manufacturing step.

The structural elements can be freely configured, in particular due to the manufacturing method, so that different, advantageous functions can be realized. Particularly expedient functions are, as already suggested above, chip breaking, chip guidance, operating means guidance, friction reduction, and thermal conduction, optionally also in combination.

Accordingly, in one advantageous configuration, the structural elements are each configured as a chip breaker for breaking chips generated by the main cutting edge. This is particularly advantageous in the event that the surface is the chip face which directly adjoins the main cutting edge, so that the structural elements also lie directly behind the main cutting edge and a chip already comes into contact with the structural elements directly upon generation of the chip and is influenced accordingly. In the design as a chip breaker, the structural elements act such that a chip is prematurely broken longitudinally and, when viewed in the direction of the longitudinal axis A, only short chips are generated (e.g., with a length of <50 mm). By contrast, the formation of long chips is prevented. In addition to, or instead of, such a breaking in length, a breaking in width is also advantageous, i.e., a breaking in the chip viewed transversely and in the radial direction, so that a plurality of narrow chips (in particular having a width of <2 mm) are generated side-by-side instead of a single, wide chip (in particular having a width of 2 mm or greater). Alternatively or in addition to a breaking of the chip, it is compressed or deformed by the structural elements.

In one suitable configuration, the structural elements are each configured in a pyramidal, triangular, or linear shape. Such geometries have been found to be particularly suitable for one or more of the aforementioned functions, specifically for chip breaking, compression, deforming, and chip guidance. A combination of differently shaped structural elements is also expedient. The structural elements are expediently aligned in a uniform manner. In the case of a chip face with structural elements, these preferably face the main cutting edge, e.g., triangular structural elements have a tip facing the main cutting edge, and linear structural elements face the front (towards the main cutting edge) with one end and face away from it with an opposite further end, e.g., into the grooved face or generally towards the rear side of the drill head.

In principle, it is already advantageous when only individual structural elements are configured, e.g., 2 to 10 pieces, which are arranged at a comparatively large distance (e.g., >1 mm) from one another. This is understood to mean that two structural elements are spaced apart by at least half of the structural dimensions (length, width, height, diameter) of a single structural element. However, an alternative design is also advantageous, in which a plurality, in particular 10 to 300, of structural elements are arranged in a plurality of rows and columns and thus form a macro-structure. The macro-structure is thus in particular a matrix-like arrangement of a plurality of structural elements. The distance between two adjacent structural elements is preferably rather low, i.e., maximum 1 mm or less than half the structural dimension of a single structural element. The structural elements are also expediently arranged without gaps and are thus directly adjacent to one another (distance=0 mm). With the formation of the macro-structure, the exact opposite of a smooth surface, namely a profiled surface, is realized. In this way, a lotus effect can in particular be realized for the surface, so that chips and/or operating means do not adhere or only poorly adhere to the surface and are thus removed more effectively. The macro-structure also significantly reduces the contact surface of the chips to the drill head, so that friction, heat development, and wear are also reduced accordingly (to some extent, such an effect also results for merely individual structural elements). Particularly pyramidal structural elements, optionally with a capped tip, and in general any shapes that can be arranged gaplessly and matrix-like (specifically in rows and columns), are suitable for the macro-structure. In one advantageous configuration, the structural elements completely cover the surface.

Preferably, the surface is also provided with structural elements continuously along at least one half of the main cutting edge, preferably along a radially outward-lying half of the main cutting edge, starting at a cutting corner or a lateral face of the drill head. For this configuration, the surface is in particular the chip face or the open face. A configuration in which the surface is provided with structural elements along the main cutting edge without any gaps until a point of the drill head is also suitable. Advantageously, the point with a number of structural elements is also to be configured alternatively or additionally.

In a suitable configuration, the structural elements are each configured as a peak. The surface therefore has a base face from which the structural elements extend upwards, so to speak, and generally project. By contrast, there is generally also a suitable design in which the structural elements are each configured as a valley, i.e., projecting into the drill head, so to speak. In principle, peaks and valleys can also be combined with one another. The structural elements have a height (or equivalently a depth) measured perpendicular to the surface, which is preferably less than a structural dimension (width, length, diameter) towards the surface, more specifically towards its base surface. The structural elements are therefore in particular flat.

In a further, suitable configuration, the structural elements are configured as channels, i.e., channel-shaped grooves. This is particularly advantageous in the case of a chip face and/or grooved face and generally a chip flute with structural elements. The channels preferably extend towards the main cutting edge. Channels are a special case for valleys. Channels are particularly advantageous, because both a chip breaking and a guidance of the operating means can be implemented therewith. The chip-breaking is carried out in particular in the width, as already described above. The operating means guidance is realized, in particular, in such a way that an operating means is distributed, to the greatest extent possible, along the entire main cutting edge and/or as evenly as possible along the main cutting edge. The channels do not necessarily have to run straight, i.e., linearly, but can be configured to have almost any path, in order to achieve an optimal distribution of coolant and/or lubricant, in particular starting from an operating means outlet. The channels are configured either equidistantly or at different distances to one another.

Preferably, the structural elements are guided up to the main cutting edge and divide it into a plurality of sub-sections. The main cutting edge is thus interrupted by the structural elements into a plurality of sub-sections. In this way, a breaking of the chip in its width is realized (see also above). For this design, the structural elements are preferably each configured as a valley, but this is not mandatory.

In a configuration with channels, they terminate in a suitable configuration in front of the main cutting edge so that it is configured without interruption. This stands in contrast to a main cutting edge interrupted in sub-sections. The structural elements are only guided to the main cutting edge up to a certain distance, but only in such a way that the main cutting edge remains intact overall and in particular has a continuous configuration.

A configuration in which the drill head comprises an operating means outlet, which is preferably arranged in the chip flute, for supplying an operating means into the structural elements is also expedient. In the following, a coolant is assumed as the operating means, without limiting its generality. In particular, the drill comprises an operating means channel, which typically extends from a rear side of the drill towards a front side of the drill and optionally also terminates there in a further operating means outlet. A respective operating means outlet is in particular a simple opening. During operation, due to the operating means outlet, operating means is for example dispensed into and then distributed within the chip flute. Additional guiding surfaces or channels are now provided by the structural elements, through which the operating means reaches particularly close to the main cutting edge without being held back by chips. Accordingly, the structural elements are suitably sized such that they are not clogged by chips. The guide surfaces are then more spaced apart than a chip is large, or the channels are narrower than a chip, respectively.

Suitably, the structural elements are spaced apart from the main cutting edge by a maximum of 1 mm. In general, the structural elements are preferably spaced apart from the main cutting edge by at most a distance which is selected depending on a specified chip length. For example, the specified chip length is a maximum or average chip length to be generated during operation. Any chip is to be broken, compressed, or deformed accordingly as a result of the structural elements, and thereby its length is to be limited to the specified chip length. The specified chip length depends in particular on the specific application. The aforementioned distance of 1 mm is well suited, but other values are also conceivable. The distance between the structural element and the main cutting edge is measured in particular perpendicular to the main cutting edge and along the surface. The spacing can vary, e.g., it can increase or decrease, or it can also be constant, for various structural elements along the main cutting edge.

In a preferred configuration, the structural elements are arranged side-by-side along the main cutting edge and thus side-by-side in the radial direction. Thus, from the perspective of a chip, a front of structural elements is configured, so to speak below or behind the main cutting edge, so that it is ensured that a chip is also influenced by at least one structural element, regardless of the location along the main cutting edge at which the chip was generated.

Preferably, the structural elements each have a structural dimension of at least 0.2 mm and/or at most 3 mm. The structural dimension is preferably a dimension of the structural element measured by its surface, e.g., a width or a diameter of the structural element. However, the structural dimension meant here is preferably not a height of the structure element (which is a dimension perpendicular to the chip face). Such a height is preferably in the range of 0.1 mm to 2 mm, so that the structural elements are typically rather planar, i.e., wider than high. However, this is not mandatory in and of itself. The stated lower limit for the size of 0.2 mm can still be well realized using current additive or primary forming manufacturing methods, in particular the injection molding method mentioned above. However, with simple grinding-in, such a size is difficult to achieve.

### DESCRIPTION OF THE DRAWINGS

Exemplary embodiments of the invention are explained in more detail in the following with the aid of a drawing. The figures show schematically:

FIG. 1 a modular drill,

FIG. 2 a drill head for the drill from FIG. 1,

FIG. 3 a further drill head for the drill from FIG. 1,

FIG. 4 a further drill head for the drill from FIG. 1,

FIG. 5 a further drill head for the drill from FIG. 1,

FIG. 6 a structural element of the drill head from FIG. 2,

FIG. 7 a structural element of the drill head from FIG. 4,

FIG. 8 the drill head from FIG. 1 and different surfaces thereof.

### DETAILED DESCRIPTION

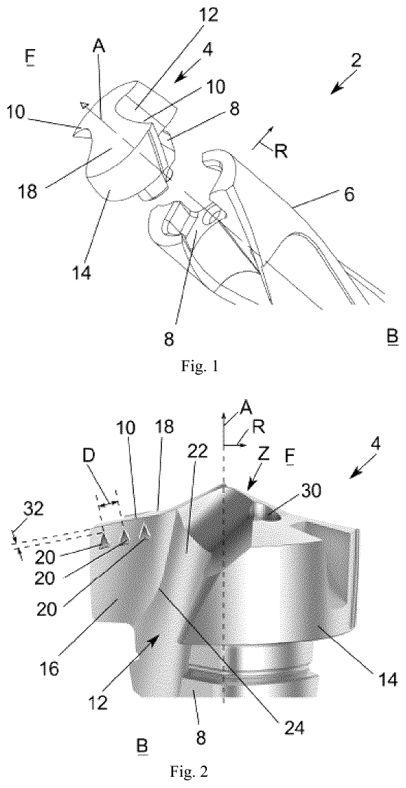

In FIG. 1, an example of a drill 2 with a drill head 4 is shown. In addition to the drill head 4, the drill 2 comprises a shaft 6, which extends in a longitudinal direction L. The drill head 4 is mounted on the front side of the shaft 6, detachably in FIG. 1 (modular drill), alternatively fixed (non-detachably fastened or integral drill). In the case of the modular drill 2 shown here, the drill head 4 comprises a coupling element 8 on the rear side for coupling to a complementary coupling element 8 of the shaft 6 arranged on the front side. The drill head 4 is not a plate-shaped insert, but is rather round and generally cylindrical or tapered in form, or a combination thereof. In the present case, the drill head 4 has a diameter that corresponds to a diameter of the shaft 6. Various exemplary embodiments for the drill head 4 are shown in FIGS. 2 to 5.

The drill head 4 comprises at least one main cutting edge 10 and one chip flute 12, which runs ahead of the main cutting edge 10. In FIGS. 2 to 5, the drill head 4 comprises a plurality of main cutting edges 10 and the same number of chip flutes 12. The main cutting edges 10 generally extend from a center Z of the drill head 4 up to a lateral face 14 of the drill head 4, i.e., from inward to outward, and thus roughly in a radial direction R. The radial direction R is perpendicular to the longitudinal axis A. “Running ahead” is understood to mean that, during operation, the chip flute 12 runs ahead of the corresponding main cutting edge 10 in a circumferential direction of the drill 2, as shown in the figures, so that chips which are generated at the main cutting edge 10 are guided into the chip flute 12 and, by means of said chip flute, towards the rear side B of the drill 2.

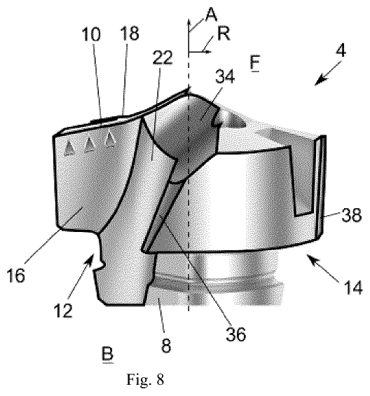

The drill head 4 comprises at least one surface 12, 14, 16, 18, 22, 34, 36, 38, with a number of structural elements 20. “A number of” is generally understood to mean “one or more.” The surface is an open face 18, a chip face 16, or a grooved face 22 of the chip flute 12, a point 34, or the lateral face 14, specifically a chamfer 36 or ancillary cutting edge 38 of the lateral face 14. To illustrate the various possible surfaces 12, 14, 16, 18, 22, 34, 36, 38 with structural elements 20, FIG. 8 shows the drill head 4 from FIG. 1 with the aforementioned surfaces 12, 14, 16, 18, 22, 34, 36, 38 outlined. On all of these surfaces 12, 14, 16, 18, 22, 34, 36, 38, structural elements 20 are advantageous. The use of the drill head 4 from FIG. 1 is merely exemplary in this case; the structural elements 20 can also be configured and/or arranged differently. The structural elements 20 are manufactured by an additive or primary forming manufacturing method. The structural elements 20 are not produced individually and/or independently of the surface 12, 14, 16, 18, 22, 34, 36, 38 and/or subsequently applied to the surface 12, 14, 16, 18, 22, 34, 36, 38, but rather are an integral component of the respective surface 12, 14, 16, 18, 22, 34, 36, 38 for manufacturing purposes.

The chip face 16 of the chip flute 12 directly adjoins the main cutting edge 10. The chip face 16 is thus the region of the chip flute 12 that first comes into contact with the chips. The chip face 16 faces in the circumferential direction and then extends at least predominantly in the direction of the longitudinal axis A as well as in the radial direction R. The chip face 16 defines the so-called chip angle, i.e., the angle between the longitudinal axis A and the chip face 16. Analogously to the chip flute 12, an open face 18 of the drill head 4 adjoins the main cutting edge 10 on the rear side.

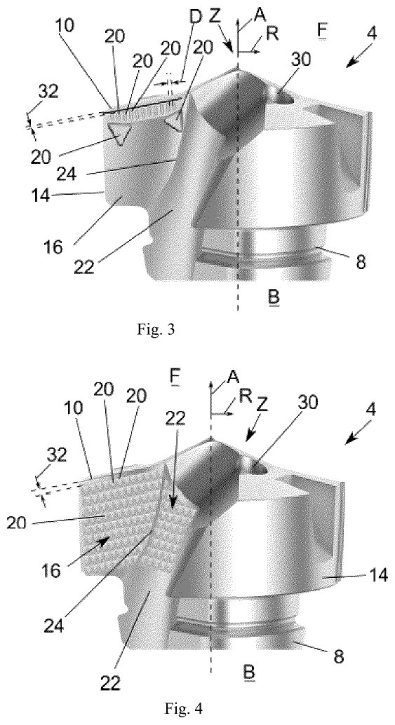

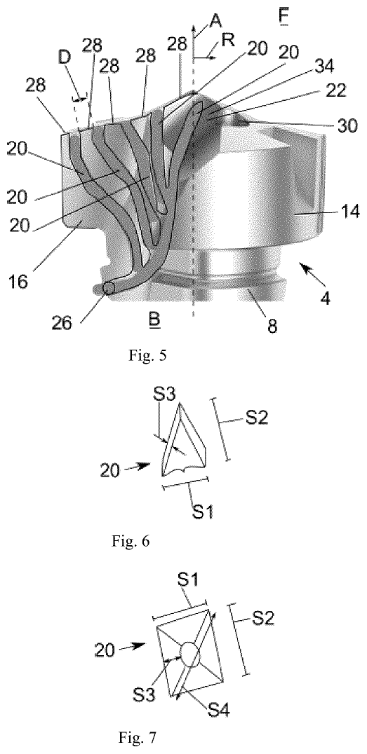

In the present case, the chip face 16 has a number of structural elements 20, i.e., it is structured, but the statements made here also apply analogously to the other surfaces 12, 14, 18, 22, 34, 36, 38. “A number of” is generally understood to mean “one or more.” In the present case, due to the structural elements 20, the chip face 16 is also macro-structured, i.e., with structural dimensions such as width S1, length S2, height S3, diameter S4, here at least 0.2 mm and at most 3 mm. The chip face 16 also has a plurality of structural elements 20, namely three pieces in FIG. 2, thirteen pieces in FIG. 3, about 150 pieces in FIG. 4, and in FIG. 5 three pieces in combination with further structural elements 20 generally in the chip flute 12. The chip face 16 is thus not merely smoothly configured, but rather structured by the additional structural elements 20, i.e., it has a non-smooth surface, which is significantly more complex than a simple smooth surface achieved by grinding-in. The structural elements 20 shown here cannot be manufactured by grinding-in with a grinding wheel. In FIG. 6, a triangular structural element 20 is shown in detail as in FIG. 2; in FIG. 7 a pyramidal structural element 20 is shown in detail as in FIG. 4. Aside from the structural elements 20 explicitly shown here, a variety of further embodiments is possible.

The structural elements 20 are part of the chip face 16, completely in FIGS. 2, 3, and 4 and predominantly (>95%) in FIG. 5, and therefore do not pass or only minimally pass into other surfaces, in FIG. 5 specifically the open face 18, of the drill head 4. The structural elements 20 thus serve solely to structure the chip face 16. Alternatively or additionally, however, a formation of structural elements 20 on the other surfaces 12, 14, 18, 22, 34, 36, 38 is also possible.

In the configurations shown here, the chip flute 12 is divided into the chip face 16 on the one hand and a grooved face 22 on the other hand. The grooved face 22 lies further inward in the drill head 4 relative to the chip face 16. The grooved face 16 is groove-shaped, i.e., concave, and thus forms a channel that opens in the radial direction R in the center Z of the drill head 4. The chip face 16 and grooved face 22 join one another at an edge 24 or alternatively continuously transition into one another (not shown). In the present case, the chip face 16 is bordered by the main cutting edge 10, the grooved face 22, and the lateral face 14. A chip generated on the main cutting edge 10 first passes to the chip face 16 and then, from there, to the grooved face 22 in order to be ultimately discharged towards the rear side B. Thus, in general, the chip face 16 forms an inlet region of the chip flute 12 for chips and serves to influence the chips by means of the structural elements 20. The grooved face 22 then serves primarily for the downstream removal of the chips. In the configuration of FIG. 4, a number of structural elements 20 are also arranged in the grooved face 22 and, in the configuration of FIG. 5, one or more of the structural elements 20 of the chip face 16 extend into the grooved face 22.

The surface 12, 14, 16, 18, 22, 34, 36, 38, in the exemplary embodiments shown here, specifically the chip flute 12 and its chip face 16, is in particular not manufactured by grinding-in with a grinding wheel, thereby avoiding the corresponding limitation of design freedom. The surface 12, 14, 16, 18, 22, 34, 36, 38 can be designed freely and independent of a grinding wheel, thereby creating completely different, previously inaccessible geometries, as can be seen in FIGS. 2 to 5, specifically for the chip face 16. The structural elements 20 manufactured in this way function as a chip breaker, a chip guide structure, an operating means guide structure (the operating means being in particular coolants and/or lubricants), a thermal conductive structure, and/or the like. A specific design for the structural elements 20 is obtained in one configuration by means of a computer simulation, in which the chip formation on the drill head 4 is simulated with the structural elements 20, taking into account a chip face 16. Accordingly, a variety of specific configurations are generally possible.

The structural elements 20 shown here are not produced individually and/or independently of the surface 12, 14, 16, 18, 22, 34, 36, 38 and/or subsequently applied to the surface 12, 14, 16, 18, 22, 34, 36, 38, but rather are an integral component of the surface 12, 14, 16, 18, 22, 34, 36, 38 for manufacturing purposes. The surface 12, 14, 16, 18, 22, 34, 36, 38 is defined in particular by the structural elements 20. In the present case, instead of grinding-in (subtractive), an additive or a primary forming manufacturing method, specifically an injection molding method, is used in order to manufacture the drill head 4 and specifically the structural elements 20. Thus, the drill head 4 along with the structural elements 20 is manufactured in an injection molding method. The drill heads 4 shown herein are each made entirely of carbide (specifically tungsten carbide). In addition, the drill heads 4 shown here are also manufactured integrally, i.e., “monolithically” or “completely from only a single material.”

After injection molding and demolding, the drill head 4 is optionally polished, e.g., with a grinding wheel. However, at least the structural elements 20, specifically the entire surface 12, 14, 16, 18, 22, 34, 36, 38, are omitted so that they remain unground. This predominantly preserves the structural elements 20, which would be lost by grinding. For the surface 12, 14, 16, 18, 22, 34, 36, 38 and specifically for its structural elements 20, the injection molding method is then the last and thus final form-determining manufacturing step.

In the exemplary embodiments of FIGS. 2, 3 and 4, the structural elements 20 are each configured as a chip breaker for breaking chips generated by the main cutting edge 10. Because the chip face 16, which is provided with the structural elements 20 by way of example here, directly adjoins the main cutting edge 10, the structural elements 20 also lie directly behind the main cutting edge 10, so that a chip already comes into contact with the structural elements 20 directly upon generation of the chip and is influenced accordingly. In the design as a chip breaker, the structural elements 20 act such that a chip generated on the main cutting edge 10 is prematurely broken longitudinally and, when viewed in the direction of the longitudinal axis A, only short chips are generated. By contrast, the formation of long chips (in particular having a length of 5 mm or greater) is prevented. In addition to, or instead of, such a breaking in length, a breaking in width is also advantageous, i.e., a breaking in the chip viewed transversely and in the radial direction R, so that a plurality of narrow chips are generated side-by-side instead of a single, wide chip.

For example, the structural elements 20 are pyramidal (FIG. 4), triangular (FIG. 2, 3) or linear (FIG. 3) in shape. A combination of differently shaped structural elements 20 is also possible, as illustrated in FIG. 3. The structural elements 20 are all aligned in a similar manner in FIGS. 2 and 4, while only some of the structural elements 20 are aligned in a similar way in FIG. 3, namely the linear structural elements 20. The structural elements 20 are also aligned facing the main cutting edge 10 in FIGS. 2 to 4.

In the exemplary embodiment of FIGS. 2 and 3, only individual structural elements 20 are configured, which are arranged at a comparatively large distance D (e.g., >1 mm) to one another. This is understood to mean that two structural elements 20 are spaced apart by at least half of the structural dimensions S1, S2, S3, S4, specifically the width S1 or length S2, of a single structural element 20. FIG. 4, on the other hand, shows a configuration in which a plurality of structural elements 20 are arranged in multiple rows and columns and, in this way, form a macro-structure, which is then a matrix-like arrangement of a plurality of structural elements 20. The distance D between two adjacent structural elements 20 is rather low, or the structural elements 20 are even arranged without gaps, as shown in FIG. 4, and are thus directly adjacent to one another (distance D=0 mm). The formation of the macro-structure realizes the exact opposite of a smooth chip face 16, namely a profiled chip face 16, whereby a lotus effect is realized. This can also be applied to the other surfaces 12, 14, 18, 22, 34, 36, 38.

In FIG. 4, the chip face 16 is also provided with structural elements 20 continuously along at least one half of the main cutting edge 10, here specifically along a radially outward-lying half of the main cutting edge 10, starting at a cutting corner or the lateral face 14. In FIG. 4, the chip face 16 is provided with structural elements 20 along the main cutting edge 10 without any gaps up to a point of the drill head 4.

In the exemplary embodiments of FIGS. 2, 3, and 4, the structural elements 20 are each configured as a peak. The surface 12, 14, 16, 18, 22, 34, 36, 38 therefore has a base face from which the structural elements 20 extend and generally project. By contrast, a design is shown e.g., in FIG. 5 in which the structural elements 20 are each configured as a valley, i.e., projecting into the drill head 4, so to speak.

In the configuration shown in FIG. 5, the structural elements 20 are configured as channels (also: channel-like grooves) that extend towards the main cutting edge 10. Channels are a special case for valleys and realize both a chip-breaking as well as an operating means guidance. The chip-breaking is carried out in the width as already described above. The operating means guidance is realized, for example, in such a way that an operating means is distributed, to the greatest extent possible, along the entire main cutting edge 10 and/or as evenly as possible along the main cutting edge 10. The channels do not necessarily have to run straight, i.e., linearly, but can be configured to have almost any path, e.g., as shown in FIG. 5, in order to achieve an optimal distribution of coolant and/or lubricant, e.g., starting from an operating means outlet 26. The grooves are configured either equidistantly or at different distances to one another.

In FIG. 5, the structural elements 20 are guided up to the main cutting edge 10 and divide it into a plurality of sub-sections 28. In this manner, a breaking of the chip in its width is realized. However, in a variant with grooves, not explicitly shown, the grooves terminate upstream of the main cutting edge 10 so that they are configured without interruption. The structural elements 20 are then only guided to the main cutting edge 10 up to a certain distance, but only in such a way that the main cutting edge 10 remains intact overall and has a continuous configuration.

The drill head 4 in FIG. 5 also comprises an operating means outlet 26, which is arranged here by way of example in the chip flute 12, for supplying an operating means into the structural elements 20. However, the operating means outlet 26 can also be located in a different surface 12, 14, 18, 22, 34, 36, 38. In particular, the drill 2 comprises an operating means channel, not explicitly designated, which typically extends from the rear side B of the drill 2 towards a front side F of the drill 2 and optionally also terminates there in a further operating means outlet 30. During operation, due to the operating means outlet 26 in the chip flute 12, operating means is dispensed into and then distributed within the chip flute 12. Additional guiding surfaces or channels are now provided by the structural elements 20, through which the operating means reaches particularly close to the main cutting edge 10 without being held back by chips.

In the present case, the structural elements 20 are spaced apart from the main cutting edge 10 by at most a distance 32 which is, for example, a fixed value of 1 mm or is selected depending on a specified chip length. The spacing 32 can vary (not shown), e.g., it can increase or decrease, or it can also be constant, for various structural elements 20 along the main cutting edge 10 (FIGS. 2 to 4).

In the exemplary embodiments of FIGS. 2 to 5, the structural elements 20 are arranged side-by-side along the main cutting edge 10 and thus side-by-side in the radial direction R. Thus, from the perspective of a chip, a front of structural elements 20 is configured, so to speak below or behind the main cutting edge 10, so that it is ensured that a chip is also influenced by at least one structural element 20, regardless of the location along the main cutting edge 10 at which the chip was generated.

Depending on which of the surfaces 12, 14, 16, 18, 22, 34, 36, 38 has a number of structural elements 20 as described, the above functions are realized to varying degrees. In the present case, by way of example, the chip-breaking was described by structural elements 20 of the chip face 16 and the operation means guidance was described by means of channels in the chip flute 16 and the point 34. Accordingly, it was not shown, for example, that a chip-breaking can also be realized in the point 34 and that a lateral face 14 with structural elements 20 primarily leads to a friction reduction, in particular between the chip and the workpiece.

1. A drill head, comprising at least one surface, with a number of structural elements,
wherein the structural elements are manufactured by an additive or primary forming manufacturing method.

2. The drill head according to claim 1, wherein the surface is a chip face directly adjoining the main cutting edge.

3. The drill head according to claim 1, wherein the surface is an open face, a grooved face of a chip flute, a point, or a lateral face.

4. The drill head according to claim 1, wherein the structural elements are each configured as a chip breaker for breaking chips generated by the main cutting edge.

5. The drill head according to claim 1, wherein the structural elements are each pyramidal, triangular, or linear in form.

6. The drill head according to claim 1, herein a plurality of structural elements are arranged in a plurality of rows and columns, thereby forming a macro-structure.

7. The drill head according to claim 1, wherein the structural elements completely cover the surface.

8. The drill head claim 1, wherein the structural elements are each peaks.

9. The drill head according to claim 1, wherein the structural elements are each valleys.

10. The drill according to claim 9, wherein the structural elements are each channels.

11. The drill head according to claim 9, wherein the structural elements are guided up to the main cutting edge and divide it into a plurality of sub-sections.

12. The drill head according to claim 10, wherein the structural elements are guided up to the main cutting edge and divide it into a plurality of sub-sections.

13. The drill head according to claim 9, wherein the structural elements terminate before the main cutting edge, so that it is uninterrupted.

14. The drill head according to claim 10, wherein the structural elements terminate before the main cutting edge, so that it is uninterrupted.

15. The drill head according to claim 1, wherein the structural elements are arranged adjacent to one another along the main cutting edge.

16. The drill head according to claim 1, wherein it is manufactured integrally.

17. A method for manufacturing a drill head according to claim 1, wherein the drill head is manufactured along with the structural elements in an additive or primary forming manufacturing method.

18. The method of claim 17, wherein the drill head is manufactured along with the structural elements in an injection molding method.

19. The method according to claim 17, wherein the drill head is subsequently polished, wherein at least the structural elements are omitted so that they remain unpolished.
